(19) United States
(12) Patent Application Publication
(10) Pub. No.: US 2008/0040962 A1
(43) Pub. Date: Feb. 21, 2008

(54) Faux window style sign

(75) Inventor: Jeffrey Gurren, Weston, CT (US)

Correspondence Address: ST. ONGE STEWARD JOHNSTON & REENS, LLC, 986 BEDFORD STREET, STAMFORD, CT, 06905-5619, US

(73) Assignee: Starlite Media LLC

(21) Appl. No.: 11/507,421

(22) Filed: Aug. 21, 2006

(51) Int. Cl. G09F 7/00

(52) U.S. Cl. 40/611.1

(57) ABSTRACT

An advertising device that is affixed to an exterior wall of a building, the device provided in the form of an exterior window with an advertisement positioned therein. The advertising device is provided with an image that may be partitioned into a first and second area. The advertisement or an image may advantageously be positioned in the first area, while the second area may be provided as a translucent or frosted look, or an opaque area. Alternatively, the second area may be provided as a second image different from the image in the first area. The advertisement gives the appearance of an exterior window on the exterior of the building to both increase the attractiveness of the building and provide for advertising in one device.

### FIELD OF THE INVENTION

The invention relates to a means for advertising on the exterior of a structure, and more specifically, the invention relates to a device that give the appearance of being a widow having an advertisement situated therein that may be mounted to the exterior of a building.

### BACKGROUND OF THE INVENTION

Many various types of advertising have been used, such as, advertisements on billboards, signs, vehicles or any other location that may be seen by relatively large numbers of potential customers. Advertisers realize that the more potential customers see their advertisements, the stronger the brand recognition becomes, which may lead to increased sales. For example, theatres regularly advertise new movie releases on the exterior of the theatre positioned within weather-proof enclosures, such as, for example, a glass-front frame holding the movie promotional therein.

A number of methods have been used over the years, such as, for example, that disclosed in U.S. Pat. No. 1,676,498 (“Lawrence”), which discloses a removable building front that may include advertisements positioned or located thereon. However, Lawrence teaches use of a building sub-front that covers the entire front of the building. While advertising may be situated on this sub-front, this is a highly cumbersome and expensive response to providing advertising on the front of a building.

Alternatively, U.S. Pat. No. 4,809,454 (“Weismen”) discloses a changeable advertising sign assembly adapted to be mounted on the interior surface of a door. Weisman therefore, fails to teach a device that may be affixed to the exterior of a building for advertising purposes.

U.S. Pat. No. 5,964,070 (“Redl et al.”) discloses a building panel system used for decoration of the facade of a building, including an inner and an outer sheet with a sign, such as a neon sign, disposed in between. However, this large metal structure gives the exterior of the building an industrial look. In addition, the use of staggered perforated material to create optical illusions is undesirable.

U.S. Pat. No. 5,265,360 (“Reiss et al.”) discloses “a window view assembly capable of being hung on a wall, much like a picture or photograph” that accentuates a perspective presentation. (Col. 1, lines 44-45.) However, Reiss et al. fails to teach a device for attachment to the exterior of a building for advertisement purposes.

For product sales, however, it is desirable to provide an inviting look to the exterior of the building, while at the same time providing for product advertisement.

### SUMMARY OF THE INVENTION

Therefore, what is desired then is relatively low-cost advertising device that may be affixed to the exterior of a building that enhances a look and feel of the building.

It is further desired to provide an advertising device that may be affixed to the exterior of a building, the advertising device providing for updating and changing of the advertisement positioned therein, while still enhancing a look of the building.

It is still further desired to provide an advertising device that may be affixed to the exterior of a building and alters the look of feel of the building to enhance the advertisement of a product associated with the advertising device.

These and other objectives are achieved, in one advantageous embodiment by the provision of false window-like structure that may be affixed to the exterior of a building. The window-like structure is provided with a plurality of image areas and gives the illusion of being a real window. The structure may have a primary image area that comprises an advertisement for a particular product and/or service, while another image area may be used that is provided as, for example, a frosted glass look or a translucent material or an opaque material. Alternatively, the second area may be provided to give the appearance of the interior of a building.

It is contemplated that the window-like structure is adapted for exterior use and as such, may be provided as a weather tight enclosure. The structure may further present a window-frame like appearance having a glass front and be accessible for removal of and changing of an insert including the advertisement.

The insert may be divided into a number of differing image areas including a primary image area that includes a visual advertisement of a particular product. In one advantageous embodiment, a second area may be provided on either side of the primary image area, the second area provided as an opaque or even a frosted or translucent material. In this manner, while the exterior of the building may not be provided with windows, the look and feel of the building may be altered to look more appealing while at the same time, provide for particular advertising.

It is contemplated that the secondary image may be selected based upon the particular product being advertised. For example, the insert may comprise multiple inserts such that the primary images and the secondary areas may be individually selected.

In one advantageous embodiment, an apparatus for advertising attachable to the exterior of a building is provided comprising a base, a frame member enclosing the base, and a cover affixed to the frame member, the frame member and the cover forming an enclosure. The apparatus further comprises an image positioned within the enclosure. The image includes a first area and a second area different from the first area. The apparatus is provided such that the first and second areas are selected from the group consisting of: an image, a translucent material, a frosted material, an opaque material, and combinations thereof and the image and the frame are formed to give the appearance of a window positioned on the exterior of the building.

In another advantageous embodiment, an advertising device affixed to the exterior of a building, the device formed in the shape of an exterior window is provided. The device comprises a frame member extending around a perimeter of the device and formed to resemble a window frame, the frame member being attached to the building via a base portion. The device further comprises an image positioned within the frame member and includes a first area for displaying an image and/or advertisement, and a second area that is different from said first area. The apparatus is provided such that the first and second areas are selected from the group consisting of: an image, a translucent material, a frosted material, an opaque material, and combinations thereof.

In still another advantageous embodiment, a method for positioning advertising on the exterior of a building, the advertising appearing to be positioned in an exterior window is provided comprising the steps of attaching a base to a wall of a building, and attaching a frame member to the base such that the frame and base are presented as an exterior window on the building. The method further comprises the steps of positioning an image between the base and frame member and partitioning the image into first and second areas, the first area being different from the second area. The method still further comprises the steps of selecting the first and second areas from the group consisting of: an image, a translucent material, a frosted material, an opaque material, and combinations thereof.

Other objects of the invention and its particular features and advantages will become more apparent from consideration of the following drawings and accompanying detailed description.

### BRIEF DESCRIPTION OF THE DRAWINGS

FIG. 1 is a front view of one advantageous embodiment of the present invention.

FIG. 1A is a front view of another advantageous embodiment of the present invention.

FIG. 2 is a cross-sectional view along Line AA of the advantageous embodiment according to FIG. 1.

FIG. 3 is a front perspective view of the advantageous embodiment according to FIG. 1.

### DETAILED DESCRIPTION OF THE INVENTION

Referring now to the drawings, wherein like reference numerals designate corresponding structure throughout the views.

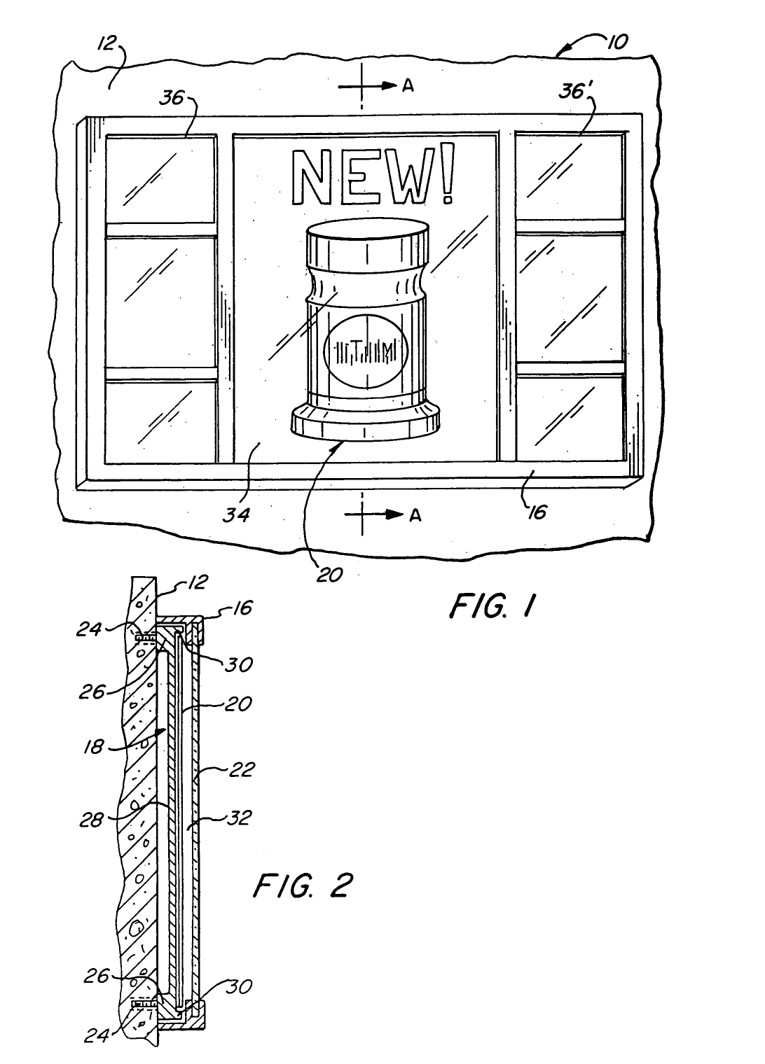

FIG. 1 is a front view of the window apparatus 10 according to one advantageous embodiment of the present invention. It is contemplated that apparatus 10 may be formed in the shape of a window such that when a potential customer views apparatus 10, the potential customer is presented with an image of an advertisement positioned within a window of a building.

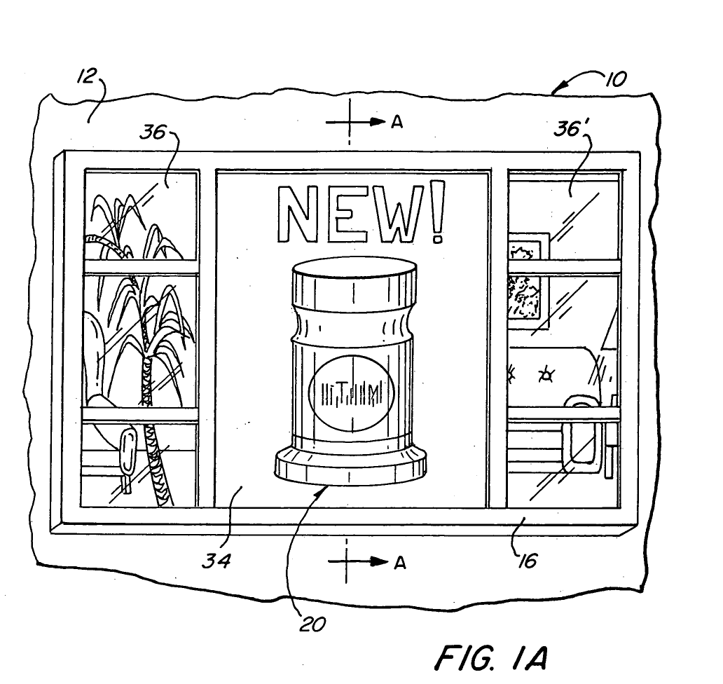

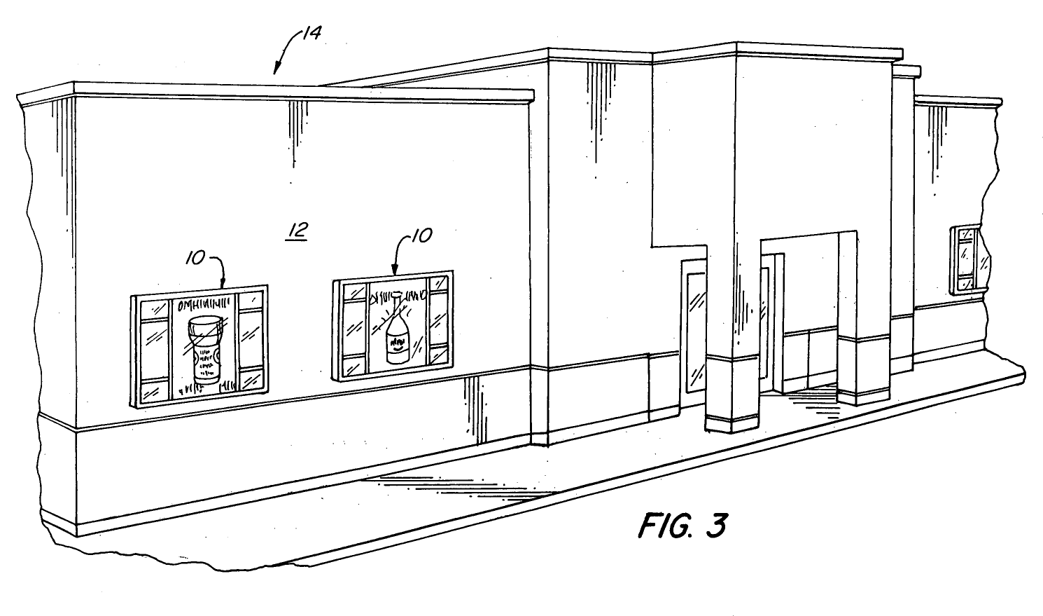

Apparatus 10 may advantageously be positioned on an exterior wall 12 of a building 14 (FIG. 3). Apparatus 10 generally comprises a frame member 16, a base 18, an image 20 and a cover 22 (FIG. 2).

It is contemplated that in one advantageous embodiment, base 18 may be secured to wall 12 by means of securing members 24. Securing members 24 may comprise, for example, bolts or masonry screws or any other appropriate device for affixing base 18 to wall 12.

As seen in FIG. 2, base 18 is formed having a plurality of supports 26, which directly contact wall 12 and through which securing member extend. Base 18 further comprises a relatively flat portion 28, which may be used, for example, to receive image 20 thereon or therein. The relatively flat portion 28 may further be terminated at end portions thereof with protrusions 30 designed to maintain or secure image 20 therein.

It is contemplated that base 18 will be formed from a robust material such as, stainless steel or other non-corrosive material. Alternatively, it is contemplated the virtually any type of relatively sturdy material may effectively be used including, for example, a hard plastic and the like.

Frame member 16 is provided in one advantageous embodiment, as an F-shaped frame member when viewed in cross-section (FIG. 2). Frame member 16 may extend around and enclose base 18 as illustrated in FIG. 2. Alternatively, it is contemplated that frame member 16 and base 18 may be provided as one integral unit. Securing means (not shown) may be provided for securing frame member 16 to base 18. For example, the securing means may comprise in one advantageous embodiment, screws, clips, pins, etc. In this manner, frame member 18 may be detachably connectable to base 18. As seen in FIG. 1, frame member 18 may be formed as a window frame and may comprise virtually any material as desired, including for example, metal, wood, plastic, alloy, etc., and may be provided with a finished or unfinished surface.

Also illustrated in FIG. 2 is cover 22, which may comprise a transparent material such as, glass, Plexiglas, plastic and so forth. Cover 22 is engagingly received in the F-shaped frame member 16 partially defining an enclosure 32 between the base 18 the frame member 16 and the cover 22 within which image 20 is positioned.

It is contemplated that frame member 16 is detachably connectable to base 18 such that image 20 may be replaced as desired.

Referring now to FIGS. 1 and 1A, it can be seen that image 20 is divided into a first image area 34 and a second image area 36, 36′. The first image area 34 may, advantageously be dedicated to an advertisement, while second image area 36, 36′ may be provided as a translucent or frosted glass look or as an opaque area, which may or may not include additional advertising. (FIG. 1) Alternatively, the second image area may be provided displaying an image representative of an interior of the building 14. (FIG. 1A) For example, in FIG. 1A, second image area 36, 36′ depicts the interior of a residence including, a partial view of a chair and plant (36) and a partial view of a couch, end table and wall painting (36′). It should be noted however, the virtually any type of image may be displayed in second image area 36, 36′. It is further contemplated that virtually any type of image may be positioned within first image area 34.

Alternatively, while image 20 has been described herein as in connection as a single piece, it is further contemplated that image 20 may comprise one or more pieces. For example, image 20 may be provided as a multi-image display, with the first image area 34 removable apart from the second image area 36, 36′. Still further, while specific configurations for the first image area 34 and second image area 36, 36′ have been illustrated in FIGS. 1-3, it is contemplated that any type of combination may be used while at the same time, still maintaining the illusion that apparatus 10 is a window on building 14. For example, the second image area 36, 36′ may comprise a continuous image area extending completely around the first image area 34, or the second image area 36, 36′ may be provided in the center portion of image 20 with one or more first image area(s) 34 variously provided on image 20. It is contemplated that many combinations may be achieved with departing from the scope of the invention.

It is further contemplated that image 20 may comprise any type of material desired, including for example, paper, plastic, board, metal, or any other type of material that may or may not be insertable into apparatus 10.

It is further contemplated that apparatus 10 may or may not be permanently affixed to wall 12. In one advantageous embodiment, it is contemplated that apparatus 12 may be moved and/or relocated on the exterior wall 12 of building 14 as desired.

Although the invention has been described with reference to a particular arrangement of parts, features and the like, these are not intended to exhaust all possible arrangements or features, and indeed many other modifications and variations will be ascertainable to those of skill in the art.

What is claimed is:

1. An apparatus for advertising attachable to the exterior of a building comprising:
a base;
a frame member enclosing said base;
a cover affixed to said frame member, said frame member and said cover forming an enclosure;
an image positioned within the enclosure, said image having:
a first area; and
a second area different from said first area;
said first and second areas selected from the group consisting of: an image, a translucent material, a frosted material, an opaque material, and combinations thereof;
said image and said frame formed to give the appearance of a window positioned on the exterior of the building.

2. The apparatus according to claim 1 wherein said cover comprises a transparent material.

3. The apparatus according to claim 2 wherein the transparent material is selected from the group consisting of: glass, Plexiglas, plastic and combinations thereof.

4. The apparatus according to claim 2 wherein the transparent material is detachably removable from said frame member.

5. The apparatus according to claim 1 wherein said base is affixed to exterior of the building via securing members.

6. The apparatus according to claim 1 wherein said image is secured to said base.

7. The apparatus according to claim 1 wherein said frame member overlays and is detachably affixed to said base.

8. The apparatus according to claim 1 wherein said image is removable from the enclosure.

9. The apparatus according to claim 1 wherein the first image area is located at a center portion of said image and the second image area is positioned on either side of the first image area.

10. An advertising device affixed to the exterior of a building, the device formed in the shape of an exterior window, the device comprising:
a frame member extending around a perimeter of the device and formed to resemble a window frame, said frame member attached to the building via a base portion;
an image positioned within the frame member and having:
a first area for displaying an image and/or advertisement; and
a second area that is different from said first area;
said first and second areas selected from the group consisting of: an image, a translucent material, a frosted material, an opaque material, and combinations thereof.

11. The advertising device according to claim 10 further comprising a transparent cover affixed to said frame member, said frame and said cover forming an enclosure.

12. The apparatus according to claim 11 wherein the transparent material is detachably removable from said frame member.

13. The apparatus according to claim 10 wherein said image is removable from said frame member.

14. The apparatus according to claim 10 wherein the first image area is located at a center portion of said image and the second image area is positioned on either side of the first image area.

15. A method for positioning advertising on the exterior of a building, the advertising appearing to be positioned in an exterior window comprising the steps of:
attaching a base to a wall of a building;
attaching a frame member to the base such that the frame and base are presented as an exterior window on the building;
positioning an image between the base and frame member;
partitioning the image into first and second areas, the first area being different from the second area; and
selecting the first and second areas from the group consisting of: an image, a translucent material, a frosted material, an opaque material, and combinations thereof.

16. The method according to claim 15 further comprising the step of enclosing the image with a transparent cover.

17. The method according to claim 15 further comprising the step of periodically replacing the image with a replacement image.

18. The method according to claim 15 wherein the first image area is located at a center portion of said image and the second image area is positioned on either side of the first image area.
